(19) United States
(12) Patent Application Publication
(10) Pub. No.: US 2024/0068622 A1
(43) Pub. Date: Feb. 29, 2024

(54) Propane Tank Gauge Assembly

(71) Applicant: Jacques Leffall, Fresno, CA (US)

(72) Inventor: Jacques Leffall, Fresno, CA (US)

(21) Appl. No.: 17/894,792

(22) Filed: Aug. 24, 2022

(51) Int. Cl. F17C 13/02

(52) U.S. Cl. CPC F17C 13/028; F17C 2221/035; F17C 2223/0153; F17C 2250/0426

(57) ABSTRACT

A propane tank gauge assembly includes a fitting that has a nozzle and a coupler surrounding the nozzle thereby facilitating the fitting to be fluidly coupled to an output port of a propane tank. A hose is fluidly coupled to the nozzle and a gauge is attached to the hose such that the gauge is in fluid communication with the interior of the propane tank when the fitting is fluidly coupled to the output port of the propane tank. The gauge has indicia applied to a face of the gauge and the indicia comprise low level indicia, medium level indicia and high level indicia. The gauge has a needle that is urged to point at a respective one of the low level indicia or the medium level indicia or the high level indicia to visually communicate the volume of liquid propane in the propane tank.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to propane gauge devices and more particularly pertains to a new propane gauge device for determining the content level of a propane tank. The device includes a fitting that is matable to an output port of a propane tank, a hose attached to the fitting and a gauge attached to the hose. The gauge has indicia printed on a face of the gauge which comprise a band having a first portion, a second portion and a third portion. Furthermore, each of the first portion and the second portion and the third portion has a color that is distinct from each other. A needle on the gauge points to either the first portion, the second portion or the third portion to visually communicate the volume level of liquid propane in the propane tank.

### (2) Description of Related Art Including Information Disclosed Under 37 CFR 1.97 and 1.98

The prior art relates to propane gauge devices including a variety of fuel gauges for a propane tank which includes a weighing element for supporting a propane tank and a gauge to indicia a fuel level of the propane tank which displays the fuel level based on the weight of the propane tank. The prior art discloses a gas detection device that includes a valve with a testing port which is attached to a propane tank and a gauge that can be attached to the testing port to detect gas escaping from the propane tank. The prior art discloses a variety of propane tank gauges that each at least includes a transmitter and a receiver for wirelessly transmitting a detected volume of a propane tank.

### BRIEF SUMMARY OF THE INVENTION

An embodiment of the disclosure meets the needs presented above by generally comprising a fitting that has a nozzle and a coupler surrounding the nozzle thereby facilitating the fitting to be fluidly coupled to an output port of a propane tank. A hose is fluidly coupled to the nozzle and a gauge is attached to the hose such that the gauge is in fluid communication with the interior of the propane tank when the fitting is fluidly coupled to the output port of the propane tank. The gauge has indicia applied to a face of the gauge and the indicia comprise low level indicia, medium level indicia and high level indicia. The gauge has a needle that is urged to point at a respective one of the low level indicia or the medium level indicia or the high level indicia to visually communicate the volume of liquid propane in the propane tank.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a propane tank gauge assembly according to an embodiment of the disclosure.

FIG. 2 is a perspective in-use view of an embodiment of the disclosure.

FIG. 3 is a front view of fitting of an embodiment of the disclosure.

FIG. 4 is a front view of a gauge of an embodiment of the disclosure.

### DETAILED DESCRIPTION OF THE INVENTION

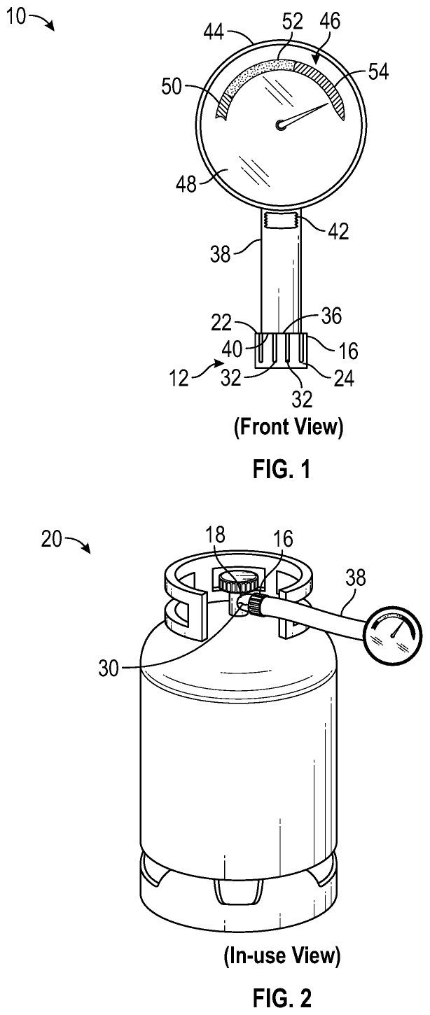

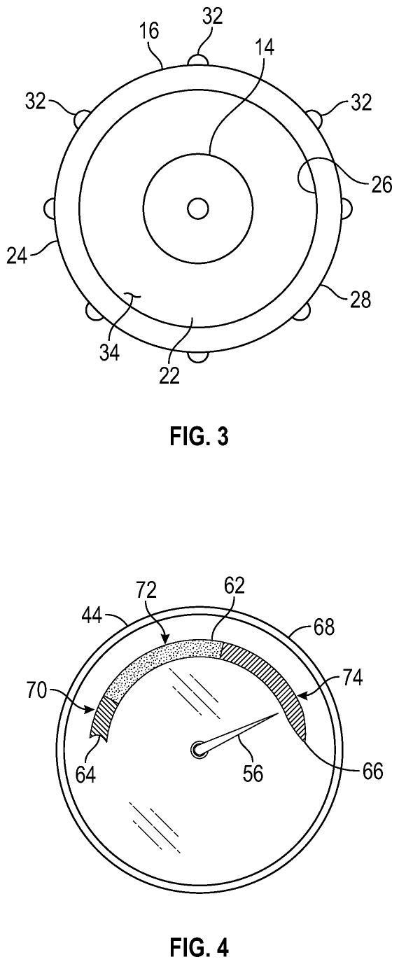

With reference now to the drawings, and in particular to FIGS. 1 through 4 thereof, a new propane gauge device embodying the principles and concepts of an embodiment of the disclosure and generally designated by the reference numeral 10 will be described.

As best illustrated in FIGS. 1 through 4, the propane tank gauge assembly 10 generally comprises a fitting 12 that has a nozzle 14 and a coupler 16 surrounding the nozzle 14 thereby facilitating the fitting 12 to be fluidly coupled to an output port 18 of a propane tank 20. The propane tank 20 may be a refillable, vertical propane tank of any conventional design and size. The coupler 16 has a rear wall 22 and a perimeter wall 24 extending away from the rear wall 22, and the perimeter wall 24 is continuously arcuate a center of the rear wall 22 such that the coupler 16 defines a cup. The perimeter wall 24 has an inside surface 26 and an outside surface 28, and the inside surface 26 is threaded thereby facilitating the inside surface 26 to threadably engage an outer surface 30 of the output port 18 of the propane tank 20.

The perimeter wall 24 has a plurality of ridges 32 integrated into the outside surface 28 to enhance gripping the coupler 16. The rear wall 22 has a front surface 34 and a back surface 36, and the perimeter wall 24 extending away from the front surface 34. The nozzle 14 extends away from the front surface 34 of the rear wall 22 and the nozzle 14 is centrally positioned on the rear wall 22 thereby facilitating the nozzle 14 to be inserted into the output port 18 of the propane tank 20 when the perimeter wall 24 of the coupler 16 is threaded onto the output port 18 thereby facilitating the nozzle 14 to be in fluid communication with an interior of the propane tank 20. The coupler 16 may comprise a Type 1 propane coupler that is commonly employed with refillable propane tanks.

A hose 38 is fluidly coupled to the nozzle 14 such that the hose 38 is in fluid communication with an interior of the propane tank 20 when the fitting 12 is fluidly coupled to the output port 18 of the propane tank 20. The hose 38 has a first end 40 and second end 42, and the hose 38 extends through the rear wall 22 of the coupler 16 such that the first end 40 is fluidly coupled to the nozzle 14. Additionally, the coupler 16 is rotatable around the hose 38 thereby facilitating the coupler 16 to the tightened or loosened on the output port 18 of the propane tank 20. The hose 38 may be comprised of a flexible material, such as rubber or other type of material that can resist being damaged by pressurized gas.

A gauge 44 is attached to the hose 38 such that the gauge 44 is in fluid communication with the interior of the propane tank 20 when the fitting 12 is fluidly coupled to the output port 18 of the propane tank 20. The gauge 44 has indicia 46 that are applied to a face 48 of the gauge 44 such that the indicia 46 are visible. The indicia 46 comprise low level indicia 50, medium level indicia 52 and high level indicia 54. Additionally, the gauge 44 has a needle 56 that is urged to point at a respective one of the low level indicia 50 or the medium level indicia 52 or the high level indicia 54 to visually communicate the volume of liquid propane in the propane tank 20. In this way a user 58 can attach the coupler 16 to the output port 18 of the propane tank 20. The gauge 44 has an input 60 and the second end 42 of the hose 38 is fluidly coupled to the input 60.

The indicia 46 comprise a band 62 that is printed on the face 48 of the gauge 44 and the band 62 has a primary end 64 and a secondary end 66. The band 62 is curved between the primary end 64 and the secondary end 66 such that the band 62 conforms to curvature of a perimeter 68 of the gauge 44. The band 62 has a first portion 70, a second portion 72 and a third portion 74. The first portion 70 extends from the primary end 64 toward the secondary end 66 and the second portion 72 extends from the first portion 70 toward the secondary end 66. The third portion 74 extends between the second portion 72 and the secondary end 66. The first portion 70 defines the low level indicia 50, the second portion 72 defines the medium level indicia 52 and the third portion 74 defines the high level indicia 54.

The first portion 70 has a first color and the second portion 72 has a second color that is distinct from the first color. The third portion 74 has a third color that is distinct from each of the first color and the second color. The first color may be red, the second color may be yellow or orange and the third color may be green. The third portion 74 has a length that is equal to a length of the second portion 72. The first portion 70 has a length that is less than the length of each of the second portion 72 and the third portion 74. The primary end 64 of the band 62 is concave and the secondary end 66 of the band 62 tapers to a point.

In use, the coupler 16 is attached to the output port 18 of the propane tank 20 to determine the volume of the liquid propane in the propane tank 20. The needle 56 of the gauge 44 moves to point toward either the first portion 70, the second portion 72 or the third portion 74 of the band 62 on the gauge 44. In this way the gauge 44 can visually communicate the volume of propane in the propane tank 20. Furthermore, a user 58 can determine whether or not the propane tank 20 needs to be refilled. In this way the user 58 can avoid running out of propane when the user 58 is cooking on a grill, for example. The coupler 16 is removed from the output of the propane tank 20 once the volume of the liquid propane in the propane tank 20 has been determined.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A propane tank gauge assembly for displaying the volume of a propane tank, said assembly comprising:
a fitting having a nozzle and a coupler surrounding said nozzle thereby facilitating said fitting to be fluidly coupled to an output port of a propane tank;
a hose being fluidly coupled to said nozzle such that said hose is in fluid communication with an interior of the propane tank when said fitting is fluidly coupled to the output port of the propane tank;
a gauge being attached to said hose such that said gauge is in fluid communication with the interior of the propane tank when said fitting is fluidly coupled to the output port of the propane tank, said gauge having indicia being applied to a face of said gauge wherein said indicia are configured to be visible, said indicia comprising low level indicia, medium level indicia and high level indicia, said gauge having a needle being urged to point at a respective one of said low level indicia or said medium level indicia or said high level indicia wherein said gauge is configured to visually communicate the volume of liquid propane in the propane tank.

2. The assembly according to claim 1, wherein:
said coupler has a rear wall and a perimeter wall extending away from said rear wall, said perimeter wall being continuously arcuate a center of said rear wall such that said coupler defines a cup, said perimeter wall having an inside surface and an outside surface, said inside surface being threaded thereby facilitating said inside surface to threadably engage an outer surface of the output port of the propane tank, said rear wall having a front surface and a back surface, said perimeter wall extending away from said front surface; and
said nozzle extends away from said front surface of said rear wall, said nozzle being centrally positioned on said rear wall thereby facilitating said nozzle to be inserted into the output port of the propane tank when said perimeter wall of said coupler is threaded onto the output port thereby facilitating said nozzle to be in fluid communication with an interior of the propane tank.

3. The assembly according to claim 2, wherein:
said hose has a first end and second end, said hose extending through said rear wall of said coupler such that said first end is fluidly coupled to said nozzle, said coupler being rotatable around said hose; and
said gauge has an input, said second end of said hose being fluidly coupled to said input.

4. The assembly according to claim 1, wherein said indicia comprise a band being printed on said face of said gauge, said band having a primary end and a secondary end, said band being curved between said primary end and said secondary end such that said band conforms to curvature of a perimeter of said gauge, said primary end of said band being concave, said secondary end of said band tapering to a point.

5. The assembly according to claim 4, wherein said band has a first portion, a second portion and a third portion, said first portion extending from said primary end toward said secondary end, said second portion extending from said first portion toward said secondary end, said third portion extending between said second portion and said secondary end, said first portion defining said low level indicia, said second portion defining said medium level indicia, said third portion defining said high level indicia.

6. The assembly according to claim 5, wherein said first portion has a first color, said second portion having a second color being distinct from said first color, said third portion having a third color being distinct from each of said first color and said second color.

7. The assembly according to claim 5, wherein said third portion has a length being equal to a length of said second portion, said first portion having a length being less than said length of each of said second portion and said third portion.

8. A propane tank gauge assembly for displaying the volume of a propane tank, said assembly comprising:
a fitting having a nozzle and a coupler surrounding said nozzle thereby facilitating said fitting to be fluidly coupled to an output port of a propane tank, said coupler having a rear wall and a perimeter wall extending away from said rear wall, said perimeter wall being continuously arcuate a center of said rear wall such that said coupler defines a cup, said perimeter wall having an inside surface and an outside surface, said inside surface being threaded thereby facilitating said inside surface to threadably engage an outer surface of the output port of the propane tank, said rear wall having a front surface and a back surface, said perimeter wall extending away from said front surface, said nozzle extending away from said front surface of said rear wall, said nozzle being centrally positioned on said rear wall thereby facilitating said nozzle to be inserted into the output port of the propane tank when said perimeter wall of said coupler is threaded onto the output port thereby facilitating said nozzle to be in fluid communication with an interior of the propane tank;
a hose being fluidly coupled to said nozzle such that said hose is in fluid communication with an interior of the propane tank when said fitting is fluidly coupled to the output port of the propane tank, said hose having a first end and second end, said hose extending through said rear wall of said coupler such that said first end is fluidly coupled to said nozzle, said coupler being rotatable around said hose; and
a gauge being attached to said hose such that said gauge is in fluid communication with the interior of the propane tank when said fitting is fluidly coupled to the output port of the propane tank, said gauge having indicia being applied to a face of said gauge wherein said indicia are configured to be visible, said indicia comprising low level indicia, medium level indicia and high level indicia, said gauge having a needle being urged to point at a respective one of said low level indicia or said medium level indicia or said high level indicia wherein said gauge is configured to visually communicate the volume of liquid propane in the propane tank, said gauge having an input, said second end of said hose being fluidly coupled to said input, said indicia comprising a band being printed on said face of said gauge, said band having a primary end and a secondary end, said band being curved between said primary end and said secondary end such that said band conforms to curvature of a perimeter of said gauge, said band having a first portion, a second portion and a third portion, said first portion defining said low level indicia, said second portion defining said medium level indicia, said third portion defining said high level indicia, said first portion extending from said primary end toward said secondary end, said second portion extending from said first portion toward said secondary end, said third portion extending between said second portion and said secondary end, said first portion having a first color, said second portion having a second color being distinct from said first color, said third portion having a third color being distinct from each of said first color and said second color, said third portion having a length being equal to a length of said second portion, said first portion having a length being less than said length of each of said second portion and said third portion, said primary end of said band being concave, said secondary end of said band tapering to a point.
